(19) United States
(12) Patent Application Publication
(10) Pub. No.: US 2023/0303395 A1
(43) Pub. Date: Sep. 28, 2023

(54) CARBON NANOTUBE COMPOSITE WIRE

(71) Applicant: TOKUSEN KOGYO CO., LTD., Ono-shi, Hyogo (JP)

(72) Inventor: Eiji OHTA, Ono-shi, Hyogo (JP)

(73) Assignee: TOKUSEN KOGYO CO., LTD., Ono-shi, Hyogo (JP)

(21) Appl. No.: 18/023,486

(22) PCT Filed: Aug. 4, 2021
(86) PCT No.: PCT/JP2021/028885

§ 371 Date: Feb. 27, 2023

(30) Foreign Application Priority Data
Oct. 30, 2020 (JP) 2020-181997

(51) Int. Cl. C01B 32/168; B22F 1/18; B22F 1/054; B22F 5/12; B22F 7/04; D06M 11/83; D06M 10/06

(52) U.S. Cl. CPC C01B 32/168; B22F 1/18; B22F 1/056; B22F 5/12; B22F 7/04; D06M 11/83; D06M 10/06; C01P 2004/02; B22F 2301/255; B22F 2302/403; B22F 2998/10; B22F 2999/00; B22F 2304/058; B22F 2007/042

(57) ABSTRACT

A carbon nanotube composite wire 2 includes: a carbon nanotube 6; and a sintered layer 8 attached to a surface of the carbon nanotube 6. The sintered layer 8 includes a large number of silver flakes 14. These silver flakes 14 are bonded to each other by sintering. Flat surfaces 16 of silver flakes 14 partly overlap, or are partly in contact with, flat surfaces 16 of other adjacent silver flakes 14. An electrically conductive network is formed by these silver flakes 14 being adjacent to each other.

### TECHNICAL FIELD

The present invention relates to a composite wire including silver flakes and a carbon nanotube.

### BACKGROUND ART

Carbon nanotubes are excellent in terms of electrical conductivity, thermal conductivity, and specific strength. Utilization of carbon nanotubes has been discussed in various fields. Each individual carbon nanotube is a fine tube. Therefore, consideration has been given to the utilization of an aggregate of a large number of carbon nanotubes as an element of a structure. Known examples of such an aggregate of carbon nanotubes include a web and a yarn.

A carbon nanotube is producible by a chemical vapor deposition method. An array of carbon nanotubes is obtained by this method. In the array, a large number of carbon nanotubes are oriented in a predetermined direction. Carbon nanotubes are gradually drawn from the array. These carbon nanotubes form a web. The web is sheet-shaped. By twisting the web, a yarn is produced.

The electrical conductivity of the yarn, which is an aggregate of the carbon nanotubes, is insufficient. Various proposals for improving the electrical conductivity of the yarn have been made.

Japanese Laid-Open Patent Application Publication No. 2011-38203 discloses a composite wire that includes carbon nanotubes and particles of gold, silver, or copper. The composite wire includes a large number of twisted carbon nanotubes. The gold, silver, or copper particles are dispersed on these carbon nanotubes. These particles can contribute to the electrical conductivity of the composite wire.

Japanese Laid-Open Patent Application Publication No. 2018-53408 discloses a composite wire that includes carbon nanotubes and silver particles. In the composite wire, a layer of a large number of silver particles is attached to the carbon nanotubes. The silver particles are bonded to each other by sintering. The layer of the silver particles can contribute to the electrical conductivity of the composite wire.

### CITATION LIST

### Patent Literature

PTL 1: Japanese Laid-Open Patent Application Publication No. 2011-38203
PTL 2: Japanese Laid-Open Patent Application Publication No. 2018-53408

### SUMMARY OF INVENTION

### Technical Problem

In the case of the composite wire disclosed by Japanese Laid-Open Patent Application Publication No. 2011-38203, the electrical conductive effect exerted by the metal powder is limited.

The electrical conductivity of the composite wire disclosed by Japanese Laid-Open Patent Application Publication No. 2018-53408 is also insufficient. In addition, in the case of this composite wire, the sintered layer of the silver particles lacks flexibility. If this composite wire is used in a bent state, it causes damage to the sintered layer

An object of the present invention is to provide a carbon nanotube composite wire having excellent electrical conductivity and excellent flexibility.

### Solution to Problem

A carbon nanotube composite wire according to the present invention includes: a carbon nanotube; and a sintered layer attached to a surface of the carbon nanotube. The sintered layer includes a large number of silver flakes. The silver flakes are bonded to each other by sintering.

A carbon nanotube composite wire according to another aspect of the present invention includes: a large number of carbon nanotubes; and a sintered layer attached to a surface of each of the carbon nanotubes. The sintered layer includes a large number of silver flakes. The silver flakes are bonded to each other by sintering.

A carbon nanotube composite wire according to yet another aspect of the present invention includes: a yarn; and a sintered layer attached to a surface of the yarn. The yarn includes a large number of carbon nanotubes. The sintered layer includes a large number of silver flakes. The silver flakes are bonded to each other by sintering.

A carbon nanotube composite wire according to yet another aspect of the present invention includes: a yarn; and a second sintered layer attached to a surface of the yarn. The yarn includes a large number of filaments. Each of the filaments includes a carbon nanotube and a first sintered layer attached to a surface of the carbon nanotube. Each of the first sintered layer and the second sintered layer includes a large number of silver flakes. The silver flakes are bonded to each other by sintering.

A method of producing a carbon nanotube composite wire according to the present invention includes: obtaining a web, or a yarn, including a large number of carbon nanotubes; attaching a silver powder including a large number of silver flakes to the carbon nanotubes; and bonding the silver flakes to each other by sintering.

A method of producing a carbon nanotube composite wire according to another aspect of the present invention includes: obtaining a web including a large number of carbon nanotubes; attaching a silver powder including a large number of silver flakes to the carbon nanotubes; obtaining a yarn by bundling the carbon nanotubes; and bonding the silver flakes to each other by sintering.

A method of producing a carbon nanotube composite wire according to yet another aspect of the present invention includes: obtaining a web including a large number of carbon nanotubes; attaching a silver powder including a large number of silver flakes to the carbon nanotubes; obtaining a yarn by bundling the carbon nanotubes; attaching the silver powder including the large number of silver flakes to the yarn; and bonding the silver flakes included in the yarn to each other by sintering.

A method of producing a carbon nanotube composite wire according to yet another aspect of the present invention includes: obtaining a web including a large number of carbon nanotubes; obtaining a yarn by bundling the carbon nanotubes; attaching a silver powder including a large number of silver flakes to the yarn; and bonding the silver flakes to each other by sintering.

Preferably, the sintering is performed at a temperature higher than or equal to 500° C. for a period of time less than or equal to 60 seconds.

Preferably, the silver powder has an average particle diameter D50 of greater than or equal to 0.10 μm and less than or equal to 0.50 μm. Preferably, the silver powder has an average aspect ratio of greater than or equal to 20.

### Advantageous Effects of Invention

In the carbon nanotube composite wire according to the present invention, electrons are conducted through a network of silver flakes. Since the silver flakes are bonded to each other by sintering, damage to the sintered layer is less likely to be caused by bending strain on the composite wire. This composite wire has excellent electrical conductivity and excellent flexibility.

### BRIEF DESCRIPTION OF DRAWINGS

FIG. 1 is a front view of part of a carbon nanotube composite wire according to one embodiment of the present invention.

FIG. 2 is a schematic enlarged sectional view of part of the carbon nanotube composite wire of FIG. 1.

FIG. 3 is a schematic enlarged perspective view of a silver flake included in a sintered layer of the carbon nanotube composite wire of FIG. 2.

FIG. 4 is a conceptual diagram showing equipment that is used in a method of producing the carbon nanotube composite wire of FIG. 1.

FIG. 5 is a perspective view of an array that is used in the production method using the equipment of FIG. 4.

FIG. 6 is a flowchart showing the method of producing the carbon nanotube composite wire, the method using the equipment of FIG. 4.

FIG. 7 is a front view showing a process in the production method of FIG. 6.

FIG. 8 is a plan view showing the process of FIG. 7.

FIG. 9 is a microscopic photograph showing a carbon nanotube composite wire according to Example 1 of the present invention.

FIG. 10 is a microscopic photograph showing a sintered layer of the carbon nanotube composite wire of FIG. 9.

FIG. 11 is a microscopic photograph showing the sintered layer of the carbon nanotube composite wire of FIG. 9.

### DESCRIPTION OF EMBODIMENTS

Hereinafter, the present invention is described in detail based on preferred embodiments with appropriate reference to the accompanying drawings.

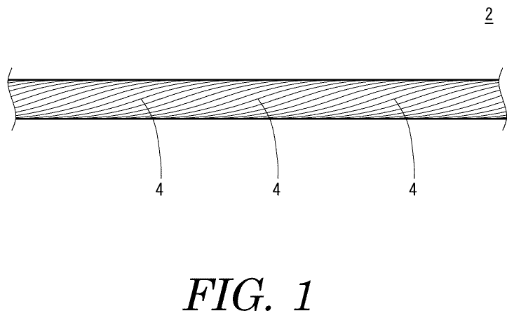

FIG. 1 shows a carbon nanotube composite wire 2 according to one embodiment of the present invention. The composite wire 2 includes a large number of filaments 4. The composite wire 2 is formed by bundling these filaments 4 together. Alternatively, the composite wire 2 may be formed by twisting the filaments 4. A plurality of composite wires 2 may be twisted together.

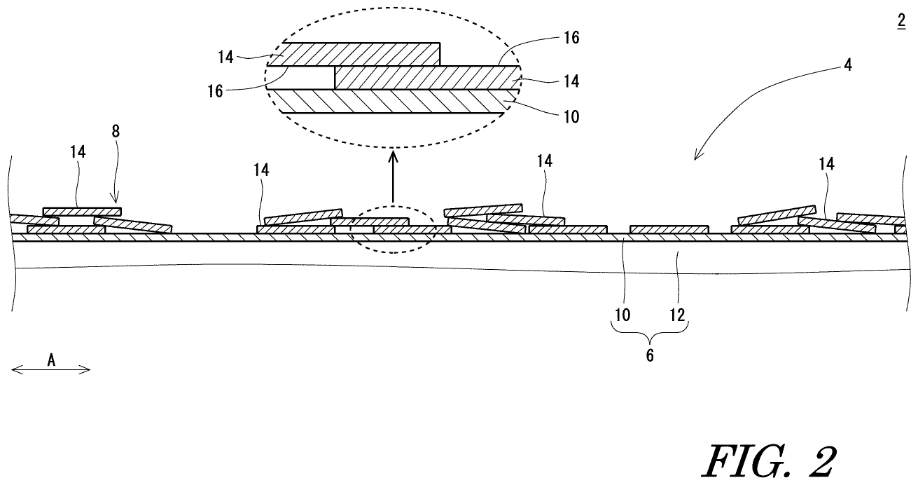

FIG. 2 schematically shows part of the carbon nanotube composite wire 2. FIG. 2 shows a filament 4 exposed on the surface of the composite wire 2. In FIG. 2, an arrow A indicates the length direction of the filament 4. The filament 4 includes a carbon nanotube 6 and a sintered layer 8.

The carbon nanotube 6 is hollow. The carbon nanotube 6 includes a carbon layer 10 and a lumen 12. The sectional shape of the carbon nanotube 6 is generally circular. Normally, the external diameter of the carbon nanotube 6 is greater than or equal to 0.5 nm and less than or equal to 100 nm. Normally, the length of the carbon nanotube 6 is greater than or equal to 0.5 μm and less than or equal to 10 mm. The carbon nanotube 6 may have a single-layer structure, a double-layer structure, or a multi-layer structure.

The sintered layer 8 is attached to the surface of the carbon nanotube 6. In FIG. 2, the sintered layer 8 covers part of the outer peripheral surface of the carbon nanotube 6. Accordingly, the carbon nanotube 6 is partly exposed. Alternatively, the sintered layer 8 may cover the entire outer peripheral surface of the carbon nanotube 6.

As shown in FIG. 2, the sintered layer 8 includes a large number of silver flakes 14. Each silver flake 14 generally extends along the length direction A. Accordingly, the thickness direction of the silver flake 14 roughly coincides with the radial direction of the carbon nanotube 6.

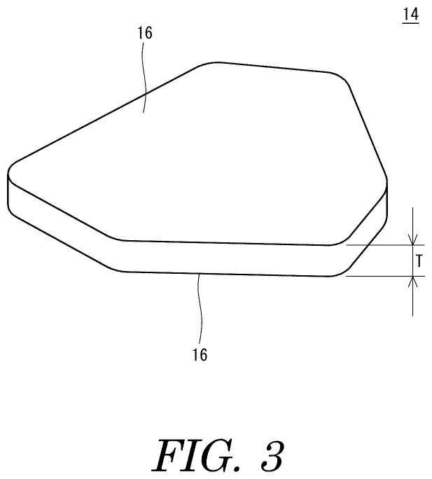

FIG. 3 is an enlarged perspective view of the silver flake 14. The silver flake 14 has a thin plate shape. The silver flake 14 includes two flat surfaces 16. Each flat surface 16 is substantially parallel to the other flat surface 16. In FIG. 3, arrows T indicate the thickness of the silver flake 14. The thickness T is the distance between one flat surface 16 and the other flat surface 16. The thickness T is relatively small. In other words, the one flat surface 16 is close to the other flat surface 16. In the present invention, a shape that can be microscopically confirmed to have the two flat surfaces 16 that are close to each other is referred to as a “flake”.

The principal component of the silver flake 14 is silver. The structure of the silver flake 14 is made up of silver crystals. The structure of the silver flake 14 may be either monocrystalline or polycrystalline. Preferably, the structure of the silver flake 14 is monocrystalline. The silver flake 14 may include a silver base and an organic compound attached to the surface of the base. The organic compound is chemically bonded to the base. The ratio of silver in the silver flake 14 is preferably greater than or equal to 99.0% by mass, and particularly preferably greater than or equal to 99.5% by mass. The silver flake 14 with no organic compound therein may be included in the sintered layer 8. The electrical resistance of the silver flake 14 whose principal component is silver is small. A flake whose principal component is copper may be used instead of, or together with, the silver flake 14.

It is clear from FIG. 2 that the flat surfaces 16 of silver flakes 14 partly overlap, or are partly in contact with, the flat surfaces 16 of other adjacent silver flakes 14. An electrically conductive network is formed by these silver flakes 14 being adjacent to each other. The sintered layer 8 including these silver flakes 14 can contribute to the electrical conductivity of the composite wire 2.

The sintered layer 8 shown in FIG. 2 is formed by sintering. By the sintering, silver flakes 14 are bonded to other adjacent silver flakes 14. These silver flakes 14 are heated by the sintering. By the heating, silver atoms can be diffused, and silver flakes 14 can be bonded to other adjacent silver flakes 14. By the heating, silver flakes 14 may melt locally. A liquid phase is formed by the melting. As a result of the liquid phase being solidified, the silver flakes 14 can be bonded to other adjacent silver flakes 14. In the sintering, the number of silver flakes 14 that entirely turn into a liquid phase is small. In other words, each silver flake 14 generally keeps its flake shape even when they are subjected to the sintering. Therefore, in a microscopic photograph of the sintered layer 8, generally, the contour of each silver flake 14 can be visually confirmed.

As previously described, the silver flakes 14 are bonded to each other locally. In addition, it is clear from FIG. 2 that the sintered layer 8 includes spaces surrounded by silver flakes 14. Accordingly, the sintered layer 8 has a great degree of deformability. The sintered layer 8 has excellent flexibility. When the composite wire 2 is bent, a bending stress, a compression stress, a tensile stress, etc., are applied to the sintered layer 8. Even though these stresses are applied to the sintered layer 8, damage such as a crack does not easily occur in the sintered layer 8. The sintered layer 8 is deformable in a manner to follow the carbon nanotube 6. In other words, the composite wire 2 has excellent flexibility. The composite wire 2 having excellent electrical conductivity and excellent flexibility is suitable for use as an electrical cable.

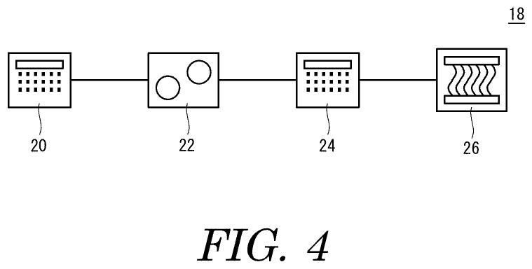

FIG. 4 shows equipment 18, which is used in a method of producing the carbon nanotube composite wire 2 of FIG. 1. The equipment 18 includes a first sprinkler 20, a bundler 22, a second sprinkler 24, and a heating furnace 26.

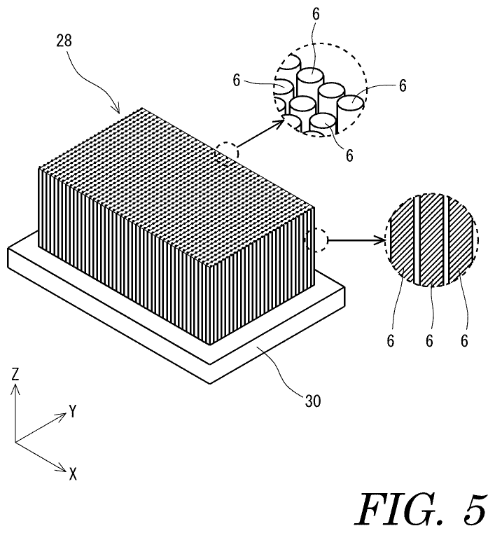

FIG. 5 shows an array 28 together with a substrate 30. The array 28 is used in the production method using the equipment 18 of FIG. 4. The array 28 is block-shaped. The array 28 is an aggregate of a large number of carbon nanotubes 6. For the sake of convenience of the description, in FIG. 5, the carbon nanotubes 6 are hatched. These carbon nanotubes 6 are oriented in the thickness direction (Z-direction) of the array 28. In other words, each carbon nanotube 6 is generally upright relative to the substrate 30. Various methods are adoptable for the production of the array 28. Typically, a chemical vapor deposition method is adopted for the production of the array 28. In this method, the carbon nanotubes 6 gradually grow upward from the substrate 30.

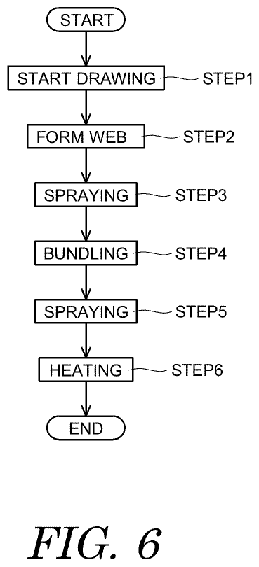

FIG. 6 is a flowchart showing the method of producing the carbon nanotube composite wire 2, the method using the equipment 18 of FIG. 4. In this production method, first, drawing of carbon nanotubes 6 from the array 28 is started (STEP 1).

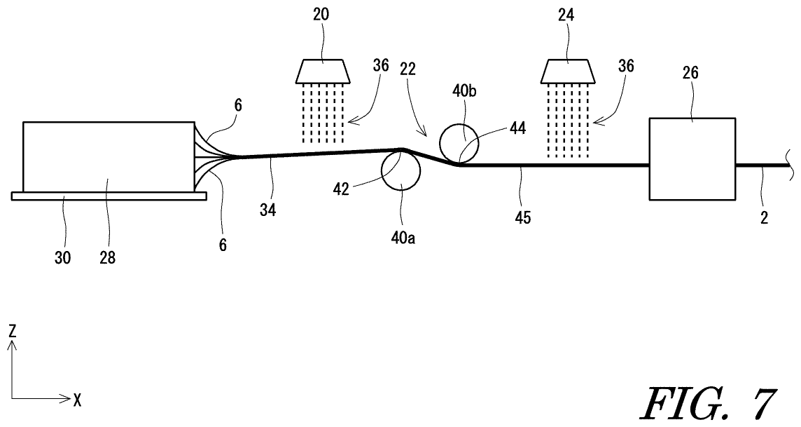

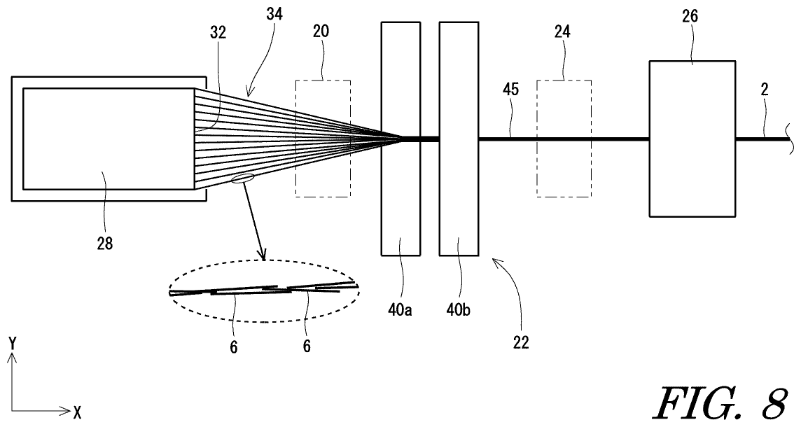

FIGS. 7 and 8 show a state where the drawing is performed. The carbon nanotubes 6 are drawn from a side surface 32 of the array 28. One or a small number of carbon nanotubes 6 are chucked and drawn. Following the drawn carbon nanotube(s) 6, other carbon nanotubes 6 are sequentially drawn from the array 28. At the time, the carbon nanotubes 6 are bonded to each other by van der Waals forces. The carbon nanotubes 6 proceed downstream (toward the right side in FIG. 7).

A web 34 is formed as a result of the drawing being continued (STEP 2). As shown in FIG. 7, the thickness (the size in the Z-direction) of the web 34 is small. As shown in FIG. 8, the width (the size in the Y-direction) of the web 34 is large. In other words, the web 34 is sheet-shaped.

The web 34 is fed to the first sprinkler 20. The first sprinkler 20 sprays (or sprinkles) a silver powder dispersion liquid 36 over the web 34 (STEP 3). A large number of silver particles are dispersed in the solvent of the dispersion liquid 36. These silver particles include silver flakes 14. Preferably, the solvent is an organic solvent, water, or an aqueous solution. Preferably, the solvent is a volatile organic solvent. Preferable examples of the organic solvent include alcohols, such as methanol and ethanol, acetone, and dimethyl sulfoxide. Preferable examples of the aqueous solution include an aqueous solution of polyvinyl alcohol. After the spraying, the solvent volatilizes. The volatilization may be facilitated by a dryer. As a result of the volatilization of the solvent, silver particles remain on the web 34. The silver particles are attached to the surfaces of the carbon nanotubes 6.

The web 34 is fed to the bundler 22. The bundler 22 includes a first roller 40a and a second roller 40b. The web 34 is passed between the first roller 40a and the second roller 40b. The top 42 of the first roller 40a is positioned at a higher elevation than the bottom 44 of the second roller 40b. Therefore, as shown in FIG. 7, the web 34 is in contact with the top 42 of the first roller 40a and the vicinity thereof, and also, the web 34 is in contact with the bottom 44 of the second roller 40b and the vicinity thereof. The web 34 in this state is receiving tensile force.

In the bundler 22, the first roller 40a moves relative to the second roller 40b. Here, the first roller 40a moves in the axial direction of the first roller 40a (i.e., in the Y-direction). Due to such motion of the first roller 40a, the carbon nanotubes 6 are rubbed against the first roller 40a and the second roller 40b. Due to the rubbing motion, the carbon nanotubes 6 become entwined with each other. The first roller 40a and the second roller 40b repeat reciprocating motion relative to each other. Due to the repeated reciprocating motion, the carbon nanotubes 6 are tightly bundled together (STEP 4). As a result of the bundling, a yarn 45 is obtained. Silver particles are dispersed on the surface of, and in the inside of, the yarn 45. These silver particles include silver flakes 14. The carbon nanotubes 6 may be bundled together with a different method. The different method is, for example, drawing with use of a die. The yarn 45 obtained from the bundling may be twisted. Alternatively, a large number of carbon nanotubes 6 that have not been bundled together may be twisted.

The yarn 45 is fed to the second sprinkler 24. The second sprinkler 24 sprays (or sprinkles) the silver powder dispersion liquid 36 over the web 34 (STEP 5). The components of the dispersion liquid 36 sprayed in this step are the same as the components of the dispersion liquid 36 sprayed by the first sprinkler 20. In other words, the dispersion liquid 36 in which a large number of silver particles are dispersed in the solvent is sprayed by the second sprinkler 24. After the spraying, the solvent volatilizes. The volatilization may be facilitated by a dryer. As a result of the volatilization of the solvent, silver particles remain on the yarn 45. The silver particles are attached to the surface of the yarn 45. The components of the dispersion liquid 36 sprayed by the second sprinkler 24 may be different from the components of the dispersion liquid 36 sprayed by the first sprinkler 20. The concentration of the dispersion liquid 36 sprayed by the second sprinkler 24 may be different from the concentration of the dispersion liquid 36 sprayed by the first sprinkler 20. The silver particles may be attached to the surface of the yarn 45 not by the spraying, but by immersion of the yarn 45 in the dispersion liquid 36.

The yarn 45 is fed to the heating furnace 26. The yarn 45 is heated in the heating furnace 26 (STEP 6). Due to the heating, silver flakes 14 are sintered to other adjacent silver flakes 14. Due to the sintering, the sintered layer 8 is formed, and the carbon nanotube composite wire 2 is obtained. A network of silver flakes 14 in the sintered layer 8 contributes to the electrical conductivity of the carbon nanotube composite wire 2. The inside of the heating furnace 26 may be an inert atmosphere, or may be an air atmosphere. In FIGS. 7 and 8, the yarn 45 is continuously fed to the heating furnace 26. The yarn 45 may be heated by batch-type heating.

Since the heating is performed at a relatively high temperature for a relatively short period of time, the bonding of silver flakes 14 to each other can be achieved while preventing the silver flakes 14 from entirely melting. In light of this, the temperature in the heating furnace 26 is preferably higher than or equal to 100° C., more preferably higher than or equal to 300° C., and particularly preferably higher than or equal to 500° C. In order to suppress volatilization of the carbon nanotubes 6 during the heating, the temperature in the heating furnace 26 is preferably lower than or equal to 800° C. The heating time is preferably greater than or equal to 1 second and less than or equal to 60 seconds. Since the heating time is a short period of time, even if the heating furnace 26 is an air-atmosphere furnace, oxidation of the yarn 45 is less likely to occur. In a case where the heating furnace 26 is an air-atmosphere furnace, the carbon nanotube composite wire 2 can be obtained at low cost.

The sintered layer 8 derived from the silver flakes 14 introduced through the spraying of the dispersion liquid 36 by the first sprinkler 20 (STEP 3) (a first sintered layer) is attached to the surface of each carbon nanotube 6. The first sintered layer contributes to the electrical conductivity mainly inside the composite wire 2. The first sintered layer may cover the entire surface of the carbon nanotube 6, or may cover part of the surface of the carbon nanotube 6. The first sintered layer that covers part of the surface of the carbon nanotube 6 can be readily fabricated. In the yarn 45, carbon nanotubes 6 to which the sintered layer 8 is attached and carbon nanotubes 6 to which the sintered layer 8 is not attached may coexist.

The sintered layer 8 derived from the silver flakes 14 introduced through the spraying of the dispersion liquid 36 by the second sprinkler 24 (STEP 3) (a second sintered layer) covers the surface of the yarn 45. The second sintered layer contributes to the electrical conductivity mainly at the surface of the composite wire 2. The second sintered layer may cover the entire surface of the yarn 45, or may cover part of the surface of the yarn 45. In light of electrical conductivity, preferably, the second sintered layer covers the entire surface of the yarn 45.

In the composite wire 2, the first sintered layer and the second sintered layer coexist. The first sintered layer and the second sintered layer are partly continuous. Therefore, in the composite wire 2, it is difficult to clearly visually recognize the boundary between the first and second sintered layers.

The spraying of the dispersion liquid 36 by the first sprinkler 20 (STEP 3) may be eliminated. In this case, silver particles are supplied only to the yarn 45 after the bundling (STEP 4). The composite wire 2 in this case includes the second sintered layer without including the first sintered layer.

The spraying of the dispersion liquid 36 by the second sprinkler 24 (STEP 5) may be eliminated. In this case, silver particles are supplied only to the web 34 before the bundling (STEP 4). The composite wire 2 in this case includes the first sintered layer without including the second sintered layer.

After the bundling (STEP 4), the yarn 45 may be heated to cause sintering of silver flakes 14, and then the dispersion liquid 36 may be sprayed over the yarn 45 (STEP 5). Thereafter, sintering by heating (STEP 6) may be further performed.

The silver powder may further include silver particles different from the silver flakes 14. Examples of the silver particles different from the silver flakes 14 include agglomerated particles, spherical particles, polyhedral particles, and helical particles.

In light of electrical conductivity, the mass ratio between the carbon nanotubes 6 and the silver particles in the composite wire 2 is preferably less than or equal to 50/50, more preferably less than or equal to 30/70, and particularly preferably less than or equal to 20/80. This ratio is preferably greater than or equal to 5/95.

In light of electrical conductivity, the ratio of the silver flakes 14 in the silver powder is preferably greater than or equal to 30% by mass, more preferably greater than or equal to 50% by mass, and particularly preferably greater than or equal to 60% by mass. This ratio is ideally 100% by mass.

Preferably, the silver powder has an average particle diameter D50 of less than or equal to 0.50 μm. The silver powder having an average particle diameter D50 of less than or equal to 0.50 μm can contribute to the electrical conductivity and flexibility of the carbon nanotube composite wire 2. In light of this, the average particle diameter D50 is more preferably less than or equal to 0.45 μm, and particularly preferably less than or equal to 0.40 μm. In light of the handleability of the silver powder, the average particle diameter D50 is preferably greater than or equal to 0.10 μm.

Preferably, the silver powder has a 95% cumulative volume particle diameter D95 of less than or equal to 1.00 μm. The silver powder having a particle diameter D95 of less than or equal to 1.00 μm can contribute to the electrical conductivity and flexibility of the carbon nanotube composite wire 2. In light of this, the particle diameter D95 is more preferably less than or equal to 0.90 μm, and particularly preferably less than or equal to 0.80 μm.

Preferably, the silver powder has a maximum particle diameter Dmax of less than or equal to 3.00 μm. The silver powder having a maximum particle diameter Dmax of less than or equal to 3.00 μm can contribute the electrical conductivity and flexibility of the carbon nanotube composite wire 2. In light of this, the maximum particle diameter Dmax is more preferably less than or equal to 2.50 μm, and particularly preferably less than or equal to 2.00 μm.

The average particle diameter D50, the 95% cumulative volume particle diameter D95, and the maximum particle diameter Dmax are measured by using a laser diffraction particle size distribution analyzer. One example of the measurement device is “LA-950V2” available from HORIBA, Ltd.

Preferably, the silver powder has an average thickness Tave of greater than or equal to 1 nm and less than or equal to 100 nm. The silver powder having an average thickness Tave of greater than or equal to 1 nm is readily producible. In light of this, the average thickness Tave is more preferably greater than or equal to 10 nm, and particularly preferably greater than or equal to 20 nm. The silver powder having an average thickness Tave of less than or equal to 100 nm can contribute to the electrical conductivity and flexibility of the carbon nanotube composite wire 2. In light of this, the average thickness Tave is more preferably less than or equal to 80 nm, and particularly preferably less than or equal to 50 nm. The average thickness Tave is calculated by averaging the thicknesses T (see FIG. 3) of randomly extracted 100 silver particles. Each of the thicknesses T is visually measured based on a SEM photograph.

Preferably, the silver powder has an aspect ratio (D50/Tave) of greater than or equal to 20. The silver powder having an aspect ratio (D50/Tave) of greater than or equal to 20 can contribute to the electrical conductivity and flexibility of the carbon nanotube composite wire 2. In light of this, the aspect ratio (D50/Tave) is preferably greater than or equal to 30, and particularly preferably greater than or equal to 35. In light of ease of production, the aspect ratio (D50/Tave) is preferably less than or equal to 1000.

Silver flakes 14 whose surfaces are smooth contribute to the electrical conductivity of the composite wire 2. Preferably, each silver flake 14 has an arithmetic mean roughness Ra of less than or equal to 10.0 nm. The arithmetic mean roughness Ra is more preferably less than or equal to 7.0 nm, and particularly preferably less than or equal to 5.0 nm. The arithmetic mean roughness Ra is measured by an atomic force microscope (AFM). The arithmetic mean roughness Ra is measured at the flat surface 16.

### EXAMPLES

Hereinafter, advantageous effects of the present invention will become apparent according to Examples. However, the present invention should not be restrictively construed based on the description of these Examples.

### Experiment 1

### Example 1

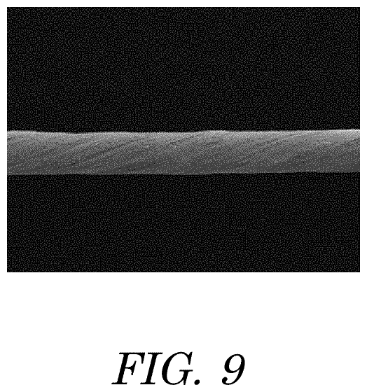

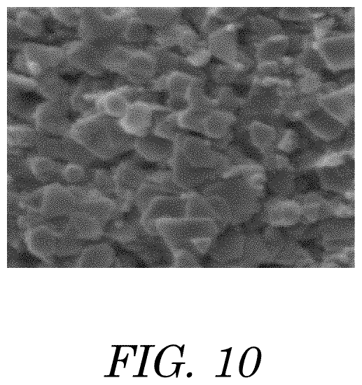

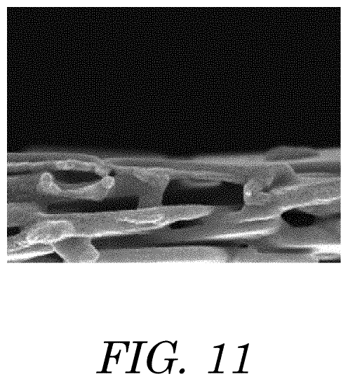

A carbon nanotube composite wire was obtained by carrying out the steps shown in FIG. 6 with use of the equipment shown in FIGS. 7 and 8. The first sprinkler and the second sprinkler each sprayed a dispersion liquid including a silver powder having an average particle diameter D50 of 0.23 μm. The silver powder included silver flakes. In the obtained composite wire, the mass ratio between carbon nanotubes and silver particles was 10/90. The diameter of the composite wire was about 20 μm. FIG. 9 shows a microscopic photograph of the composite wire. FIG. 10 shows an enlarged microscopic photograph of the composite wire as seen in the radial direction. FIG. 11 shows a further enlarged microscopic photograph showing a cross section of the sintered layer.

### Examples 2 to 4

Carbon nanotube composite wires were obtained in the same manner as Example 1 except that, in each of Examples 2 to 4, a silver powder having an average particle diameter D50 as shown in Table 1 below was used.

### Comparative Example 1

A composite wire was obtained in the same manner as Example 1 except that, in the heating step of Comparative Example 1, the heating was performed for a long period of time such that the silver powder entirely melted. In the obtained composite wire, the silver flakes lost their original shape.

### Comparative Example 2

A composite wire was obtained in the same manner as Example 1 except that, in Comparative Example 2, the heating by a heating furnace was not performed. In the obtained composite wire, the silver flakes were not sintered to each other.

### Comparative Example 3

A carbon nanotube composite wire was obtained in the same manner as Example 1 except that, in Comparative Example 3, spherical silver particles were used.

### Comparative Example 4

A carbon nanotube yarn was obtained in the same manner as Example 1 except that, in Comparative Example 4, the spraying of the silver powder dispersion liquid was not performed.

[Electrical Conductivity]

The electrical resistivity of each composite wire (or yarn) was measured. The measurement results, together with grading, are shown in Tables 1 and 2 below.

[Crack Resistance]

Each composite wire (or yarn) was wound around a cylinder, and then restored. The surface of the composite wire was observed, and graded in accordance with the criteria indicated below. The grading results are shown in Tables 1 and 2 below.
A: no cracks in the filaments.
B: minute cracks in a small number of filaments.
C: minute cracks in a large number of filaments.
D: large cracks in the filaments.

TABLE 1
Results of Experiment 1

| | Example 1 | Example 2 | Example 3 | Example 4 |
|---|---|---|---|---|
| Shape of silver | Flake | Flake | Flake | Flake |
| particles | | | | |
| D50 (μm) | 0.23 | 0.40 | 0.49 | 1.22 |
| Production method | Sintering | Sintering | Sintering | Sintering |
| Mass ratio | 10/90 | 10/90 | 10/90 | 10/90 |
| Electrical resistivity | 3.6E−08 | 5.0E−08 | 5.8E−08 | 9.5E−08 |
| (Ω/m) | | | | |
| Electrical conductivity | A | A | A | B |
| Crack resistance | A | A | A | B |

TABLE 2
Results of Experiment 1

| | Comp. | Comp. | Comp. | Comp. |
|---|---|---|---|---|
| | Ex. 1 | Ex. 2 | Ex. 3 | Ex. 4 |
| Shape of silver | Flake | Flake | Spher- | — |
| particles | | | ical | |
| D50 (μm) | 0.23 | 0.23 | 0.45 | — |
| Production method | Melting and | Dis- | Sinter- | — |
| | Solid- | persion | ing | |
| | ification | | | |
| Mass ratio | 10/90 | 10/90 | 10/90 | — |
| Electrical resistivity | 1.5E−08 | 9.1E−06 | 1.6E−07 | 3.0E−05 |
| (Ω/m) | | | | |
| Electrical conductivity | A | D | C | D |
| Crack resistance | D | A | C | A |

As shown in Tables 1 and 2, the carbon nanotube composite wires of the respective Examples have excellent electrical conductivity and excellent crack resistance. These evaluation results clearly indicate the superiority of the present invention.

### Experiment 2

### Example 5

A carbon nanotube composite wire was obtained with use of the equipment shown in FIGS. 7 and 8. The first sprinkler sprayed a dispersion liquid including a silver powder having an average particle diameter D50 of 0.23 μm. The silver powder included silver flakes. The spraying of a dispersion liquid by the second sprinkler was not performed. In the obtained composite wire, the mass ratio between carbon nanotubes and silver particles was 50/50. The diameter of the composite wire was about 100 μm.

### Examples 6 to 8

Carbon nanotube composite wires were obtained in the same manner as Example 5 except that, in each of Examples 6 to 8, a silver powder having an average particle diameter D50 as shown in Table 3 below was used.

### Comparative Example 5

A composite wire was obtained in the same manner as Example 5 except that, in the heating step of Comparative Example 5, the heating was performed for a long period of time such that the silver powder entirely melted. In the obtained composite wire, the silver flakes lost their original shape.

### Comparative Example 6

A composite wire was obtained in the same manner as Example 5 except that, in Comparative Example 6, the heating by a heating furnace was not performed. In the obtained composite wire, the silver flakes were not sintered to each other.

### Comparative Example 7

A carbon nanotube composite wire was obtained in the same manner as Example 5 except that, in Comparative Example 7, spherical silver particles were used.

[Electrical Conductivity]

The electrical resistivity of each composite wire (or yarn) was measured. The measurement results, together with grading, are shown in Tables 3 and 4 below.

[Crack Resistance]

Each composite wire (or yarn) was wound around a cylinder, and then restored. The surface of the composite wire was observed, and graded in accordance with the criteria indicated below. The grading results are shown in Tables 3 and 4 below.
A: no cracks in the filaments.
B: minute cracks in a small number of filaments.
C: minute cracks in a large number of filaments.
D: large cracks in the filaments.

TABLE 3
Results of Experiment 2

| | Example 5 | Example 6 | Example 7 | Example 8 |
|---|---|---|---|---|
| Shape of silver | Flake | Flake | Flake | Flake |
| particles | | | | |
| D50 (μm) | 0.23 | 0.40 | 0.49 | 1.22 |
| Production method | Sintering | Sintering | Sintering | Sintering |
| Mass ratio | 50/50 | 50/50 | 50/50 | 50/50 |
| Electrical resistivity | 5.5E−07 | 7.0E−07 | 8.1E−07 | 1.2E−06 |
| (Ω/m) | | | | |
| Electrical conductivity | A | A | A | B |
| Crack resistance | A | A | A | B |

TABLE 4
Results of Experiment 2

| | Comp. | Comp. | Comp. | Comp. |
|---|---|---|---|---|
| | Ex. 5 | Ex. 6 | Ex. 7 | Ex. 4 |
| Shape of silver | Flake | Flake | Spher- | — |
| particles | | | ical | |
| D50 (μm) | 0.23 | 0.23 | 0.45 | — |
| Production method | Melting and | Dispersion | Sinter- | — |
| | Solid- | | ing | |
| | ification | | | |
| Mass ratio | 50/50 | 50/50 | 50/50 | — |
| Electrical resistivity | 3.1E−07 | 1.1E−05 | 2.2E−06 | 3.0E−05 |
| (Ω/m) | | | | |
| Electrical conductivity | A | D | C | D |
| Crack resistance | D | A | C | A |

As shown in Tables 3 and 4, the carbon nanotube composite wires of the respective Examples have excellent electrical conductivity and excellent crack resistance. These evaluation results clearly indicate the superiority of the present invention.

### INDUSTRIAL APPLICABILITY

The carbon nanotube composite wire according to the present invention is applicable to various applications in which electrical conductivity is required.

### REFERENCE SIGNS LIST

2 carbon nanotube composite wire
4 filament
6 carbon nanotube
8 sintered layer
12 carbon layer
14 silver flake
16 flat surface
20 first sprinkler
22 bundler
24 second sprinkler
26 heating furnace
28 array
34 web
36 dispersion liquid
40a first roller
40b second roller
45 yarn

1. A carbon nanotube composite wire comprising:
a carbon nanotube; and
a sintered layer attached to a surface of the carbon nanotube, wherein
the sintered layer includes a large number of silver flakes, and
the silver flakes are bonded to each other by sintering.

2. A carbon nanotube composite wire comprising:
a large number of carbon nanotubes; and
a sintered layer attached to a surface of each of the carbon nanotubes, wherein
the sintered layer includes a large number of silver flakes, and
the silver flakes are bonded to each other by sintering.

3. A carbon nanotube composite wire comprising:
a yarn; and
a sintered layer attached to a surface of the yarn, wherein
the yarn includes a large number of carbon nanotubes,
the sintered layer includes a large number of silver flakes, and
the silver flakes are bonded to each other by sintering.

4. A carbon nanotube composite wire comprising:
a yarn; and
a second sintered layer attached to a surface of the yarn, wherein
the yarn includes a large number of filaments,
each of the filaments includes a carbon nanotube and a first sintered layer attached to a surface of the carbon nanotube,
each of the first sintered layer and the second sintered layer includes a large number of silver flakes, and
the silver flakes are bonded to each other by sintering.

5. A method of producing a carbon nanotube composite wire, the method comprising:
obtaining a web, or a yarn, including a large number of carbon nanotubes;
attaching a silver powder including a large number of silver flakes to the carbon nanotubes; and
bonding the silver flakes to each other by sintering.

6. The method according to claim 5, comprising:
obtaining the web including the large number of carbon nanotubes;
attaching the silver powder including the large number of silver flakes to the carbon nanotubes;
obtaining a yarn by bundling the carbon nanotubes; and
bonding the silver flakes to each other by sintering.

7. The method according to claim 6, comprising:
obtaining the web including the large number of carbon nanotubes;
attaching the silver powder including the large number of silver flakes to the carbon nanotubes;
obtaining the yarn by bundling the carbon nanotubes;
attaching the silver powder including the large number of silver flakes to the yarn; and
bonding the silver flakes included in the yarn to each other by sintering.

8. The method according to claim 5, comprising:
obtaining the web including the large number of carbon nanotubes;
obtaining a yarn by bundling the carbon nanotubes;
attaching the silver powder including the large number of silver flakes to the yarn; and
bonding the silver flakes to each other by sintering.

9. The method according to claim 5, wherein
the sintering is performed at a temperature higher than or equal to 500° C. for a period of time less than or equal to 60 seconds.

10. The method according to claim 5, wherein
the silver powder has an average particle diameter D50 of greater than or equal to 0.10 μm and less than or equal to 0.50 μm.

11. The method according to claim 5, wherein
the silver powder has an average aspect ratio of greater than or equal to 20.
